(19) United States
(12) Patent Application Publication
(10) Pub. No.: US 2026/0257528 A1
(43) Pub. Date: Sep. 3, 2026

(54) LOCKING DEVICE FOR CHASSIS ACTUATOR

(71) Applicant: Schaeffler Technologies AG & Co. KG, Herzogenaurach (DE)

(72) Inventors: Sicheng Song, Auburn Hills, MI (US); Timothy Jacques, Auburn Hills, MI (US)

(73) Assignee: Schaeffler Technologies AG & Co. KG, Herzogenaurach (DE)

(21) Appl. No.: 19/553,924

(22) Filed: Mar. 2, 2026

Related U.S. Application Data
(60) Provisional application No. 63/765,836, filed on Mar. 3, 2025.

(51) Int. Cl. B60G 17/015; B60G 17/005

(52) U.S. Cl. CPC B60G 17/0157; B60G 17/005; B60G 2204/4604

(57) ABSTRACT

A vehicle chassis actuator includes an electric motor, a housing, a geartrain disposed within the housing, and a double-wrap spring disposed within the geartrain. The double-wrap spring prevents back-driving of the geartrain via locking: i) of an outer coil array of the double-wrap spring against a housing, and ii) locking of an inner coil array of the double-wrap spring against a gearwheel of the geartrain.

### CROSS-REFERENCE TO RELATED APPLICATIONS

This application claims priority to U.S. Provisional Application 63/765,836 filed Mar. 3, 2025, the entire disclosure of which is incorporated by reference herein.

### TECHNICAL FIELD

This disclosure is generally related to a chassis actuator, particularly a locking device for a chassis actuator.

### BACKGROUND

Chassis actuators of a vehicle may be utilized to steer a pair of wheels, disconnect a stabilizer bar, or modify a vehicle body ride height. In some chassis actuators, a locking device is required to enable different operational states.

### SUMMARY

A vehicle chassis actuator is provided that includes an electric motor, a geartrain drivably connected to the electric motor, and a spring disposed circumferentially around one gearwheel of the geartrain. The spring may lock with the one gearwheel in order to prevent back-driving of the gear train.

In an example embodiment, the spring is a wrap spring. In a further aspect, the spring is a double-wrap spring having an inner coil array nested within an outer coil array. The inner coil array and the outer coil array may be formed via one continuous strand.

In an example embodiment, the electric motor and the geartrain are disposed within a housing. The housing may include a vehicle suspension spring seat fixed to the housing, and actuation of the geartrain linearly moves the geartrain and the vehicle suspension spring seat in unison along an actuation axis.

In an example embodiment, the housing includes a cylindrical bushing fixed to the housing and disposed around the spring, and the spring locks with the cylindrical bushing so as to prevent back-driving of the geartrain.

In an example embodiment, the chassis actuator also includes a screw drive, and the geartrain drives the screw drive. In a further aspect, the screw drive includes a screw thread arranged on a vehicle attachment body, and actuation of the geartrain by the electric motor moves the electric motor and geartrain relative to the vehicle attachment body via the screw drive.

In an example embodiment, the vehicle chassis actuator is a ride height actuator.

In an example embodiment, the geartrain includes a gearwheel fixed to a threaded nut of a screw drive that converts rotary motion to linear motion.

An example embodiment of a vehicle chassis actuator is provided that includes a housing, an electric motor fixed to the housing, a transmission disposed within the housing and having at least one rotatable transmission wheel drivably connected to the electric motor, and a wrap spring simultaneously locked to one of the at least one rotatable transmission wheel and the housing via an interference fit. The wrap spring may be a double-wrap spring having an inner coil array nested within an outer coil array. In a further aspect, rotation of the one of the at least one rotatable transmission wheel in a first rotational direction causes: i) the wrap spring, or the outer coil array thereof, to lockably engage the housing, and ii) the wrap spring, or the inner coil array thereof, to unlockably disengage from the one of the at least one rotatable transmission wheel. In yet a further aspect, rotation of the one of the at least one rotatable transmission wheel in a second rotational direction causes: i) the wrap spring, or the outer coil array thereof, to unlockably disengage from the housing, and ii) the wrap spring, or the inner coil array thereof, to lockably engage the one of the at least one rotatable transmission wheel.

In an example embodiment, the vehicle chassis actuator also includes a screw drive that is rotatably driven by the transmission, and the wrap spring prevents back-driving of the screw drive.

### BRIEF DESCRIPTION OF THE DRAWINGS

FIG. 1 is a perspective view of a cross-section of an example embodiment of a chassis actuator.

FIG. 2 is a perspective view of a geartrain of the chassis actuator of FIG. 1.

FIG. 3 is a detailed view taken from FIG. 1.

FIG. 4 is a perspective view of a drive tube of the chassis actuator of FIG. 1.

FIG. 5A is a perspective view of an example embodiment of a double-wrap spring for the chassis actuator of FIG. 1.

FIG. 5B is a perspective view of the double-wrap spring of FIG. 5A.

FIG. 6A is a top view of the double-wrap spring of FIG. 5A during a raising operation of the chassis actuator.

FIG. 6B shows a simplified cross-sectional view of the double-wrap spring of FIG. 5A during a raising operation of the chassis actuator, identifying unlocked and locked condition locations. FIG. 6B is simplified for clarity purposes, and does not show every feature of the double-wrap spring.

FIG. 7A shows a top view of the double-wrap spring of FIG. 5A during a holding operation of the chassis actuator.

FIG. 7B shows a simplified cross-sectional view of the double-wrap spring of FIG. 5A during a holding operation of the chassis actuator, identifying locked condition locations. FIG. 7B is simplified for clarity purposes, and does not show every feature of the double-wrap spring.

FIG. 8A shows a top view of the double-wrap spring of FIG. 5A during a lowering/back-drive operation of the chassis actuator.

FIG. 8B shows a simplified cross-sectional view of the double-wrap spring of FIG. 5A during a lowering/back-drive operation of the chassis actuator, identifying unlocked and locked condition locations. FIG. 8B is simplified for clarity purposes, and does not show every feature of the double-wrap spring.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

The term “wrap spring” is a known term to describe a spring with helical coils that may be installed around an arbor or a shaft. The wrap spring may be configured to lockably engage and unlockably disengage from the arbor or shaft depending on a direction of rotation of the arbor or shaft, which, in effect, winds or unwinds the wrap spring. Such lockably engaging and unlockably disengaging by the wrap spring occurs via a respective increase or decrease in a normal force applied by the helical coils to a mating radial surface of the arbor or shaft.

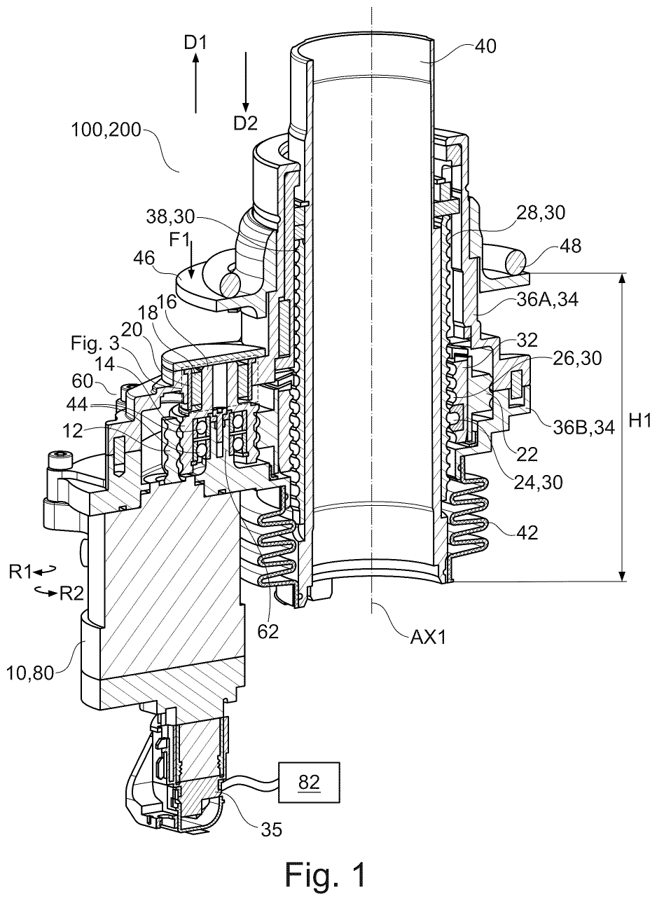

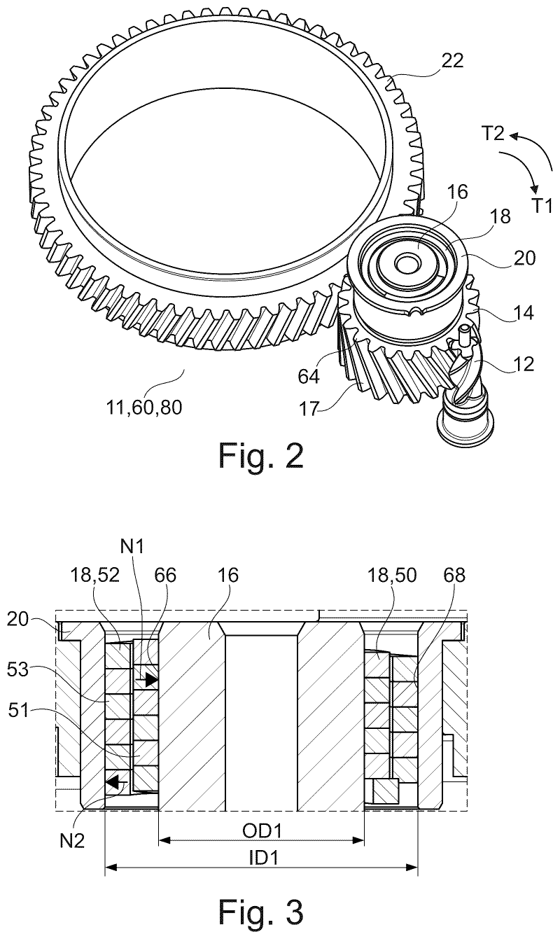

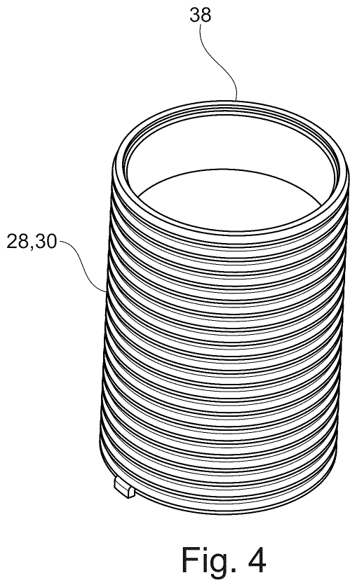

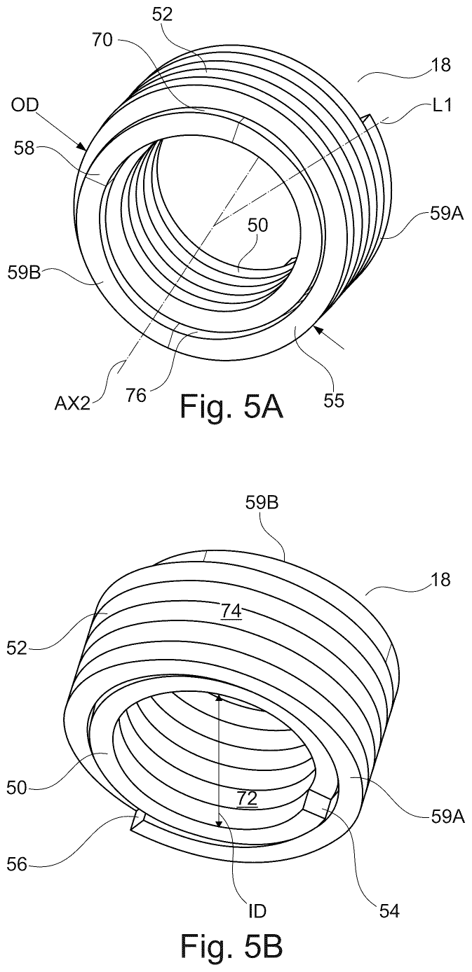

FIG. 1 is a perspective view of a cross-section of an example embodiment of a chassis actuator 100. The chassis actuator 100 may be a ride height actuator 200, as depicted in FIG. 1. FIG. 2 is a perspective view of a geartrain 11 of the chassis actuator 100. FIG. 3 is a detailed view taken from FIG. 1 that shows a double-wrap spring 18 that fulfills a function of a rotational lock that prevents the chassis actuator 100 from being back-driven. FIG. 4 shows a perspective view of a drive tube 38 of the chassis actuator 100. FIGS. 5A and 5B show different perspective views of the double-wrap spring 18. The following should be read in light of FIGS. 1 through 5B.

The chassis actuator 100 includes an electric motor 10 that is attached to a housing 34 that includes an upper housing 36A and a lower housing 36B that are fixed together via fasteners (not shown). A spring seat 46 is fixed to the upper housing 36A and serves as a landing for an end of a spring 48 of a vehicle suspension system. The electric motor 10 is controlled by an electronic controller 82 that electronically communicates with the electric motor 10 via an electrical connector 35. The electric motor 10 drives a transmission 60 formed by the geartrain 11. The geartrain 11 includes a first or input gearwheel 12, which could also be described as a pinion; a second or idler gearwheel 14 (meshed with the first gearwheel 12) that is supported on a raised boss 62 of the lower housing 36B via rolling element bearings 44; and a third or output gearwheel 22 (meshed with the second gearwheel 14) that is fixed to an outer circumference of a ball nut 32 via any suitable fixing means. Any suitable transmission, geartrain and gear types could be utilized instead of those shown in the figures. The ball nut 32 forms a portion of a screw drive 30. Together, the electric motor 10, the geartrain 11, and the screw drive 30 form a powertrain 80 that converts rotary motion of the electric motor 10 to linear motion of the screw drive 30. The ball nut 32 is formed with a radially outer screw thread 26, formed as a ball track, that engages, via balls 24, a radially inner screw thread 28, formed as a ball track, of the drive tube 38; the radially outer screw thread 26, the balls 24, the radially inner screw thread 28, and the drive tube 38 are all part of the screw drive 30. The drive tube 38 is fixed to an outer circumference of a vehicle attachment body 40 that is fixed to a vehicle; the vehicle attachment body 40 remains stationary during adjustment of a ride height. The vehicle attachment body 40 may be any suitable shape or component other than what is shown. Further, the drive tube 38, or the radially inner screw thread 28 thereof, may be integral with the vehicle attachment body 40. When the electric motor 10 rotates in a first rotational direction R1 (clockwise when viewed from top) to rotatably drive the geartrain 11, the electric motor 10, geartrain 11, ball nut 32, and housing 34 elevate or “climb” the drive tube 38 along an actuation axis AX1 in a first direction D1. Upward movement of the spring seat 46 facilitates an increased elevation of a vehicle body, or a ride height thereof, as defined by a spring seat height H1. When the electric motor 10 rotates in a second rotational direction R2 to rotatably drive the geartrain 11, the electric motor 10, geartrain 11, ball nut 32, and housing 34 descend or move downward along the actuation axis AX1 in a second direction D2. Downward movement of the spring seat 46 facilitates a decreased elevation of the vehicle body, or the ride height thereof. A bellows 42 is fixed to a bottom of the vehicle attachment body 40 and to a bottom of the lower housing 36B which serves to seal the interface between these two components while permitting relative linear travel between them. A location of the spring seat 46 can be moved to any suitable location within the chassis actuator 100; for example, the spring seat 46 could serve as an upper spring seat instead of a lower spring seat.

In an example embodiment, the electronic controller 82 controls the chassis actuator 100 to achieve a plurality of predetermined “discrete” ride heights, as defined by the spring seat height H1. In a further example embodiment, the electronic controller 82 controls the chassis actuator 100 to move the spring seat 46 to any desirable spring seat height H1 within a defined range of heights, defining a characteristic of a fully variable ride height actuator. A fully variable ride height actuator may stop at or start from any spring seat height H1 within the defined range of heights and move to any other desirable height within the defined range of heights.

The term “back-driven” and “back-driving” are known terms that signify that a force or torque applied to an output transmission element will rotate or displace a corresponding input transmission component. For example, during normal operation, actuation or rotation of an input element causes actuation or linear displacement of an output element; back-driving occurs when a load applied to the output element actuates the input element. Thus, in the context of this disclosure, the double-wrap spring 18 provides a means of preventing the transmission 60 from being back-driven, so that a torsional force applied to the output gearwheel 22 can not actuate the input gearwheel 12. It could also be stated that the double-wrap spring 18 provides a means of preventing the powertrain 80 from being back-driven, so that a body force F1 applied to the spring seat 46 does not translate through the screw drive 30 and geartrain 11 to cause actuation of the input gearwheel 12 and reduce the spring seat height H1. In further example embodiments, the screw drive 30 may be replaced with any other suitable linear drive system.

In both its free state (non-installed state) and an initial installed state, the following characteristics apply to the double-wrap spring 18. The double-wrap spring 18 includes an inner coil array 50 that is nested within an outer coil array 52 via one continuous strand 55 that has a first strand end 54, a second strand end 56, and a transition portion 58 that connects or adjoins the inner coil array 50 to the outer coil array 52. The term “coil array” is meant to signify one or more individual coils that are grouped together. For example, as shown in FIG. 3, the inner coil array 50 may include six inner coils 51, and the outer coil array 52 may include five outer coils 53. Any suitable number of inner and outer coils may be present to accomplish the locking and unlocking tasks described herein. The inner coil array 50 may be concentric to the outer coil array 52, each corresponding to a central axis AX2. A line L1 orthogonal to the central axis AX2 (extending inside of the double-wrap spring 18) passes through or intersects one of the inner coils 51 and one of the outer coils 53 in succession. The inner coil array 50 and the outer coil array 52 may be wound in the same direction. The first strand end 54 is part of the inner coil array 50 and the second strand end 56 is part of the outer coil array 52. The double-wrap spring 18 has a first longitudinal end 59A that includes both the first strand end 54 and the second strand end 56, and a second longitudinal end 59B that includes the transition portion 58. It should be noted that the double-wrap spring 18 is continuously cylindrical on both its inner diameter ID and outer diameter OD; stated otherwise, the first and second strand ends 54, 56 are legless and do not include features that facilitate attachment or fixing of the first and second strand ends 54, 56 to an adjacent component. In an example embodiment, neither of the first and second strand ends 54, 56 extend outside of the curvature of the respective inner and outer coil arrays 50, 52. Variations of any of the previously described geometric characteristics of the double-wrap spring 18 are possible to satisfy its “back-driving prevention” function. For example, the inner and outer coil arrays may be non-concentric and the first and second strand ends may have legs or form any suitable shape. Based on the previously described geometric characteristics, the double-wrap spring 18 could also be described as a double-coil spring, a double-nested-coil spring, or a double-coil torsion wrap spring.

The double-wrap spring 18 may be installed around a cylindrical extension 16 of the second gearwheel 14. The cylindrical extension 16 could also be referred to as a post or protrusion. The cylindrical extension 16 extends axially from an axial face 64 of the second gearwheel 14; therefore, it could be stated that the double-wrap spring 18 is disposed on the second gearwheel 14 at a location that is axially offset from a toothed portion 17 of the second gearwheel 14. In an example embodiment, the cylindrical extension 16 is integral with the second gearwheel 14. In an example embodiment, the cylindrical extension 16 is pressed into the second gearwheel 14. The cylindrical extension 16 serves as both a locking interface and a sliding interface for the inner coil array 50 of the double-wrap spring 18.

The double-wrap spring 18 may be disposed within a cylindrical bushing 20, which could also be referred to as a cylindrical sleeve. The cylindrical bushing 20 is fixed to the upper housing 36A via any suitable fixing method so that it can not move relative to the upper housing 36A (axially, rotationally, or otherwise). As shown in the figures, the cylindrical bushing 20 is a separate component from the upper housing 36A; however, in an example embodiment, the cylindrical bushing 20 is integral with the upper housing 36A. The cylindrical bushing 20 serves as a locking interface for the outer coil array 52 of the double-wrap spring 18. The outer coil array 52 ultimately engages and locks with the upper housing 36A, regardless of whether the bushing 20 is present.

For the sake of this disclosure, the term “lockably engaged” refers to a gripped or clenched state between the inner or outer coil arrays and respective radial surfaces of the second gearwheel 14 or upper housing 36A; in addition, the term “unlockably disengaged” refers to a relaxed state between the inner or outer coil arrays and the respective radial surfaces of the second gearwheel 14 or upper housing 36A during which sliding engagement occurs. The term “disengaged” does not mean separated or that a radial gap is present between radial surfaces. Therefore, such a sliding engagement between the respective radial surfaces provides a drag torque that will be described in the following paragraphs. Further, the term “unlockably separated” or “separated” refers to state in which two radial surfaces are not in contact with each other, and therefore, are not locked together.

The double-wrap spring 18 becomes smaller when a first applied torque T1 acts in the first rotational direction R1. When such a first applied torque T1 acts on the inner coil array 50, the inner coil array 50 wraps tighter (tightens its grip) around the cylindrical extension 16 such that an increase in normal force N1 occurs between a radial inner surface 72 of the inner coil array 50 (or at least one coil thereof) and a radial outer surface 66 of the cylindrical extension 16. The increase in normal force N1 can facilitate a frictionally locked state; thus, it could be stated that the inner coil array 50 is lockably engaged with the cylindrical extension 16 in this state. When such a first applied torque T1 acts on the outer coil array 52, the outer coil array 52 lessens its grip on the cylindrical bushing 20 such that a decrease in normal force N2 occurs between a radial outer surface 74 of the outer coil array 52 (or at least one coil thereof) and a radial inner surface 68 of the cylindrical bushing 20. The decrease in normal force N2 can facilitate a frictionally unlocked state in which a slip fit is present; thus, it could be stated that the outer coil array 52 is unlockably disengaged with the cylindrical bushing 20 in this state.

The double-wrap spring 18 becomes larger when a second applied torque T2 acts in the second rotational direction R2. When the second applied torque T2 acts on the inner coil array 50, the inner coil array 50 lessens its grip on the cylindrical extension 16 such that a decrease in normal force N1 occurs between the radial inner surface 72 of the inner coil array 50 (or at least one coil thereof) and the radial outer surface 66 of the cylindrical extension 16. The decrease in normal force N1 can facilitate a frictionally unlocked state in which the cylindrical extension 16 becomes slidably movable relative to the inner coil array 50; thus, it could be stated that the inner coil array 50 is unlockably disengaged with the cylindrical extension 16 in this state. When such a second applied torque T2 acts on the outer coil array 52, the outer coil array 52 tightens its grip against the radial inner surface 68 of the cylindrical bushing 20 such that an increase in normal force N2 occurs between the radial outer surface 74 of the outer coil array 52 and the cylindrical bushing 20. The increase in normal force N2 can facilitate a frictionally locked state; thus, it could be stated that the outer coil array 52 is lockably engaged with the cylindrical bushing 20 in this state.

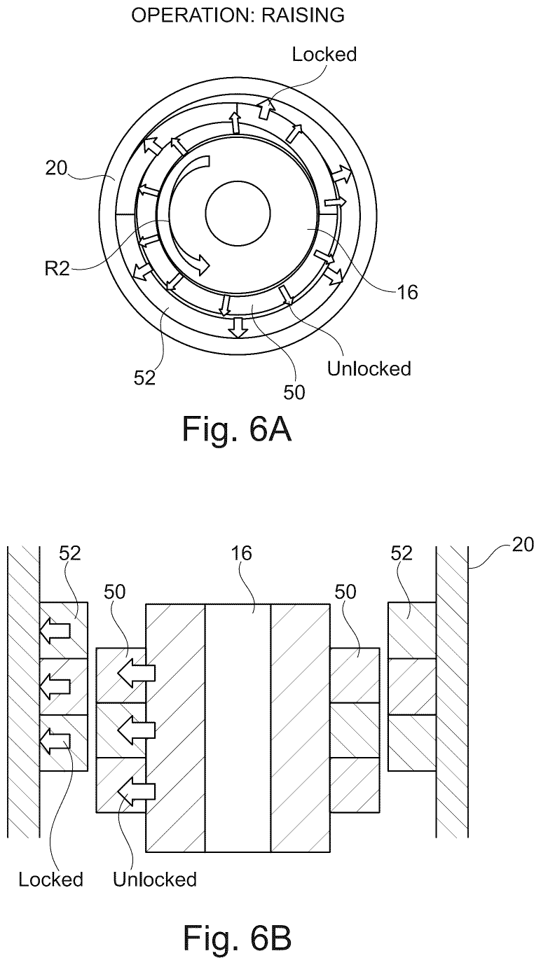

The respective fits and locking characteristics of the double-wrap spring 18 will now be described for: i) an “as-shipped” condition (before installation in a vehicle), ii) as-installed in a vehicle, and iii) three different modes of function for the ride height actuator 200, as depicted within FIGS. 6A through 8B: raising, holding, and lowering.

During an assembly process of the chassis actuator 100, the double-wrap spring 18 is installed with an interference fit with both the cylindrical bushing 20 of the upper housing 36A and the cylindrical extension 16 of the second gearwheel 14. That is, in a relaxed state of the double-wrap spring 18 during the initial assembly process, the interference fit that is present between the outer coil array 52 and the cylindrical bushing 20 and the inner coil array 50 and the cylindrical extension 16 facilitates a frictionally locked state. The term “interference fit” in this instance signifies that, before assembly: i) an outer diameter OD of the outer coil array 52 is larger than an inner diameter ID1 of the cylindrical bushing, and ii) an inner diameter ID of the inner coil array 50 is smaller than an outer diameter OD1 of the cylindrical extension 16. The chassis actuator 100 may remain in this frictionally locked state in an “as-shipped” state, which may provide a torsional locking between the double-wrap spring 18 and both the cylindrical bushing 20 and cylindrical extension 16 up to a pre-determined torque threshold referred to as a breakthrough torque.

An example embodiment of an equation to determine a breakthrough torque between: i) the radial inner surface 72 of the inner coil array 50 and the radial outer surface 66 of the cylindrical extension 16, and ii) the radial outer diameter surface 74 of the outer coil array 52 and the radial inner surface 68 of the cylindrical bushing 20, is as follows:

$$Breakthrough Torque = - ( \frac{2 * ( a - r ) * I * E}{{d}_{m}^{2} * 1000} ) * ( {e}^{- {i}^{*} * 2 π * μ} - 1 )$$

$$Where :$$

$$( a - r ) = diametral interference between spring and cylindrical interface , installed$$

$$I = moment of Inertia , spring$$

$$E = elastic modulus , spring$$

$${d}_{m} = coil winding diameter ( inner or outer coil array ) , installed$$

$${i}^{*} = installed active windings$$

$$μ = minimum friction coefficient$$

$$e = 2.71828 ( mathematical constant )$$

When the chassis actuator 100 is installed in a vehicle, the weight of the body of the vehicle compresses the spring 48 which induces the force F1 on the spring seat 46. It is desirable that the force F1 does not back-drive the transmission 60 so that the height H1 of the spring seat 46 is maintained. Therefore, the double-wrap spring 18 and its respective fits with the radial outer surface 66 of the cylindrical extension 16 and the radial inner surface 68 of the cylindrical bushing 20 should ensure that slippage does not occur at these interfaces. Thus, referring to the above equation, a diametral interference fit between the double-wrap spring 18 and both the cylindrical extension 16 and the cylindrical bushing 20 remains after the chassis actuator is installed in the vehicle, representing an “as installed” state, to ensure a rotationally locked condition.

Turning to FIGS. 6A and 6B, a first function of raising a vehicle body via the chassis actuator 100 is depicted from a perspective of the double-wrap spring 18. In this instance, the first gearwheel 12 is rotated in the first rotational direction R1 (clockwise when viewed from top) by the electric motor 10 which induces rotation of the second gearwheel 14 in the second rotational direction R2. In this instance the double-wrap spring 18 is unwound such that: i) the inner coil array 50 relaxes its grip on the outer diameter OD1 of the cylindrical extension 16, and ii) the outer diameter OD of the outer coil array 52 tightens its grip on the inner diameter ID1 of the cylindrical bushing 20 (or grips it more firmly). In this state: i) the second gearwheel 14 (or cylindrical extension 16 thereof) has a looser fit with the double-wrap spring 18 which enables a low breakthrough torque or low drag torque condition, signifying a frictionally unlocked state, and ii) the cylindrical bushing 20, which is fixed to the upper housing 36A, has a tighter fit with the outer coil array 52 which enables a high breakthrough torque condition, signifying a frictionally locked state. In this frictionally locked state, the outer coil array 52 is non-rotatably engaged with the outer coil array 52 as long as the applied torque to this interface is less than its breakthrough torque. In an example embodiment, the “low breakthrough torque” between the second gearwheel 14 and the double-wrap spring 18 is designed to be 0.4 Nm, which the electric motor 10 can overcome to raise the vehicle body. Other suitable torques could also be achieved by tuning of the breakthrough torque equation variables.

The looser fit between the inner coil array 50 of the double-wrap spring 18 and the cylindrical extension 16 is due to the propensity of the inner coil array 50 to want to expand to a larger inner diameter ID when the double-wrap spring 18 is unwound, which, in effect, reduces the normal force N1 at this interface. The “unlocked” arrows placed on the inner coil array 50 of FIGS. 6A and 6B illustrate this propensity or tendency. The tighter fit between the outer coil array 52 of the double-wrap spring 18 and the cylindrical bushing 20 (or outer housing 36A) is due to the propensity of the outer coil array 52 to want to expand to a larger outer diameter OD when the double-wrap spring 18 is unwound, which, in effect, increases the normal force N2 at this interface. The “locked” arrows placed on the outer coil array 52 of FIGS. 6A and 6B illustrate this propensity or tendency.

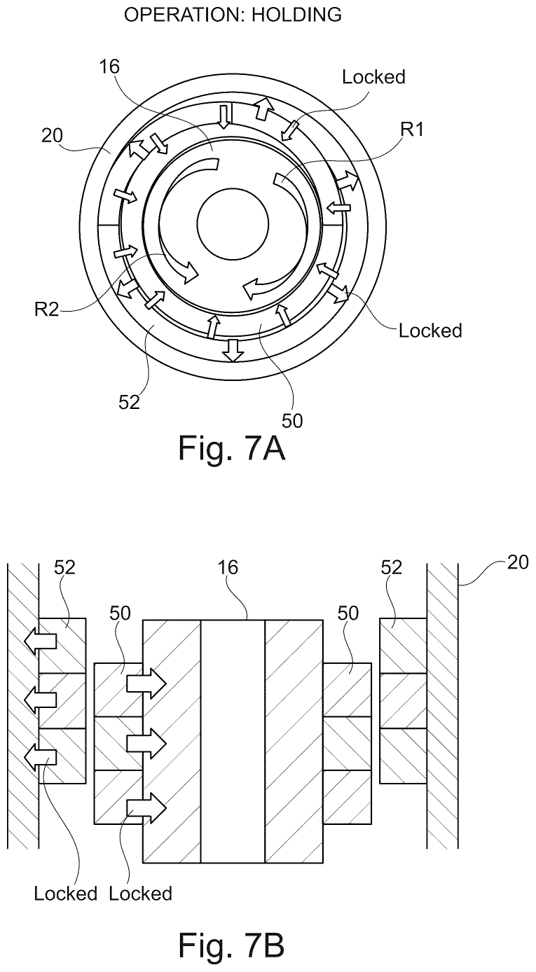

Turning to FIGS. 7A and 7B, a second function of holding or maintaining a vehicle body at any desirable height H1 within a prescribed range of heights is depicted. In this holding state, back driving of the transmission 60 via a force F1 of the spring 48 acting on the spring seat 46 does not occur, otherwise, the vehicle body will be lowered. In this holding state, the electric motor 10 is de-energized via the electronic controller 82 and no input torque is provided to the input gearwheel 12 of the geartrain 11. Such a de-energized state of the electric motor 10 returns the chassis actuator 100 to the previously described “as installed” state, in which an interference fit exists between: i) the inner diameter ID of the inner coil array 50 and the outer diameter OD1 of cylindrical extension 16, and ii) the outer diameter OD of the outer coil array 52 and the inner diameter ID1 of the cylindrical bushing 20. The “locked” arrows placed on the inner coil array 50 and outer coil array 52 of FIGS. 7A and 7B illustrate the resultant frictionally locked state at these interfaces. The height H1 will be maintained if a breakthrough torque at these interfaces is not exceeded, particularly the breakthrough torque between the radial outer surface 74 of the outer coil array 52 and the radial inner surface 68 of the cylindrical bushing 20. It should also be stated that this holding function may be maintained even during severe road loads (high F1 forces) of the vehicle induced by, for example, potholes or any other roadway inconsistencies. During such conditions, oscillating forces may also be applied to the double-wrap spring 18 while the height H1 of the vehicle body is maintained or held by the chassis actuator 100. Such oscillating forces may cause the double-wrap spring 18 to wind and unwind; however, the corresponding torques acting on the double-wrap spring 18 that result from the oscillating forces are designed to not exceed the design breakthrough torques. In an example embodiment for the “holding” operation, when a torque applied to the interface of outer coil array 52 and the cylindrical bushing 20 exceeds a threshold torque of 2.5 Nm, slippage will occur.

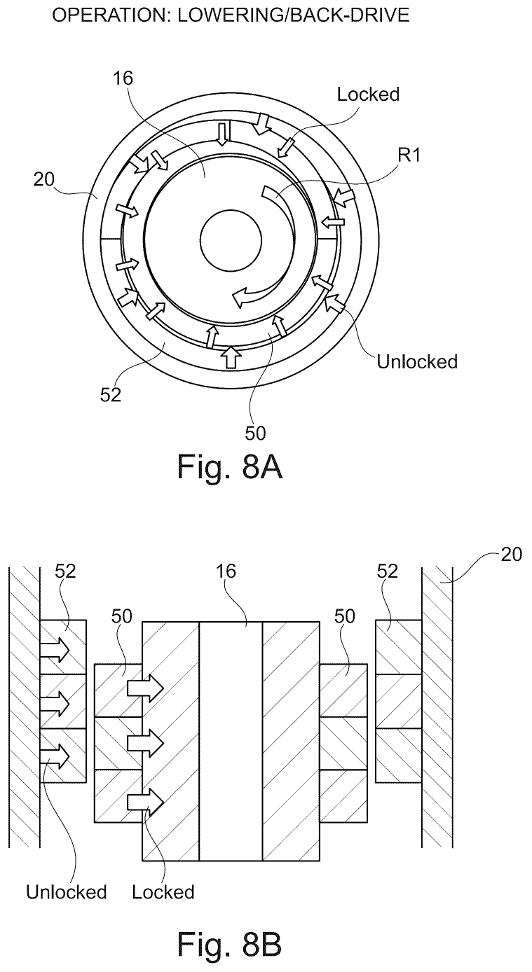

Turning to FIGS. 8A and 8B, a third function of lowering the vehicle body is depicted. In this state, the input gearwheel 12 is rotated in a counterclockwise rotation R2 via the electric motor 10 which induces a rotation of the second gearwheel 14 in the first rotational direction R1. In this lowering function, the electric motor 10, together with the force F1 applied to spring seat 46 via the spring 48, combine to wind the double-wrap spring 18 and overcome the breakthrough torque between the outer coil array 52 and the cylindrical bushing 20. “Locked” arrows are present in FIGS. 8A and 8B to depict a lockably engaged state of the inner coil array 50, while “unlocked” arrows depict rotational slippage that occurs at the interface between the outer coil array 52 and the cylindrical bushing 20. In an example embodiment, the breakthrough torque at this interface is 2.5 Nm, however, any desirable breakthrough torque may be achieved by tuning the variables of the breakthrough torque equation.

In an example embodiment, during each of the three previously described functions of the chassis actuator 100, the outer coil array 52 of double-wrap spring 18 does not contact the inner coil array 50 at any time. Therefore, it could be stated that a radial inner surface 76 of the outer coil array 52 (or at least one outer coil 53 thereof) and a radial outer surface 70 of the inner coil array 50 (or at least one inner coil 51 thereof) are continuously separated or unlockably separated. Further, the radial inner surface 76 of the outer coil array 52 (or at least one outer coil thereof) and the radial outer surface of the inner coil array 50 (or at least one inner coil 51 thereof) do not lockably engage any radial surface of the chassis actuator 100 during any of the three previously described functions. Therefore, each of these radial surfaces are continuously separated from any radial surface.

In an example embodiment, an installation of the double-wrap spring 18 could be flipped relative to the cylindrical extension 16 so that the double-wrap spring 18 becomes smaller when the second applied torque T2 is applied in the second rotational direction R2.

The double-wrap spring 18 may be installed on any rotating component of the powertrain 80 and is not restricted to only being installed on the second gearwheel 14 as shown and described herein.

The previously described chassis actuator 100 is not limited to that of a ride height actuator, and could be any of a wide array of chassis actuators, including, but not limited to a stabilizer bar disconnect or a steering actuator.

Furthermore, the previously described transmission 60 is not limited to the shown and described gearwheel transmission and may be any suitable transmission, including, but not limited to a pulley arrangement, strain wave gearing, or any other rotating wheel-type mechanism.

What is claimed is:

1. A vehicle chassis actuator, comprising:
an electric motor;
a geartrain drivably connected to the electric motor; and
a spring disposed circumferentially around one gearwheel of the geartrain, the spring configured to prevent back-driving of the geartrain.

2. The vehicle chassis actuator of claim 1, wherein the spring is a wrap spring.

3. The vehicle chassis actuator of claim 2, wherein the spring locks with the one gearwheel so as to prevent back-driving of the geartrain.

4. The vehicle chassis actuator of claim 1, wherein the spring is a double-wrap spring having an inner coil array nested within an outer coil array.

5. The vehicle chassis actuator of claim 4, wherein the inner coil array locks with the one gearwheel so as to prevent back-driving of the geartrain.

6. The vehicle chassis actuator of claim 4, wherein the inner coil array and the outer coil array are formed by one continuous strand.

7. The vehicle chassis actuator of claim 1, further comprising a housing, and the geartrain is disposed within the housing.

8. The vehicle chassis actuator of claim 7, further comprising a vehicle suspension spring seat fixed to the housing, and actuation of the geartrain linearly moves the geartrain and the vehicle suspension spring seat in unison along an actuation axis.

9. The vehicle chassis actuator of claim 7, wherein the spring locks with the housing so as to prevent back-driving of the geartrain.

10. The vehicle chassis actuator of claim 7, wherein the housing further comprises a cylindrical bushing disposed around the spring and the spring locks with the cylindrical bushing so as to prevent back-driving of the geartrain.

11. The vehicle chassis actuator of claim 1, further comprising a screw drive, and the geartrain drives the screw drive.

12. The vehicle chassis actuator of claim 11, wherein the screw drive further comprises a screw thread arranged on a vehicle attachment body.

13. The vehicle chassis actuator of claim 12, wherein actuation of the geartrain by the electric motor moves the electric motor and geartrain relative to the vehicle attachment body via the screw drive.

14. The vehicle chassis actuator of claim 1 configured as a ride height actuator.

15. The vehicle chassis actuator of claim 1, wherein the geartrain further comprises a gearwheel fixed to a threaded nut of a screw drive that converts rotary motion to linear motion.

16. A vehicle chassis actuator, comprising:
a housing;
an electric motor fixed to the housing;
a transmission disposed within the housing and having at least one rotatable transmission wheel drivably connected to the electric motor;
a wrap spring simultaneously locked to one of the at least one rotatable transmission wheel and the housing via an interference fit; and
rotation of the one of the at least one rotatable transmission wheel in a first rotational direction causes:
the wrap spring to lockably engage the housing; and
the wrap spring to unlockably disengage from the one of the at least one rotatable transmission wheel; and
rotation of the one of the at least one rotatable transmission wheel in a second rotational direction causes:
the wrap spring to unlockably disengage from the housing; and
the wrap spring to lockably engage the one of the at least one rotatable transmission wheel.

17. The vehicle chassis actuator of claim 16, wherein wrap spring is a double-wrap spring having an inner coil array nested within an outer coil array.

18. The vehicle chassis actuator of claim 17, wherein:
rotation of the one of the at least one rotatable transmission wheel in the first rotational direction causes:
the outer coil array to lockably engage the housing; and
the inner coil array to unlockably disengage from the one of the at least one rotatable transmission wheel.

19. The vehicle chassis actuator of claim 18, wherein:
rotation of the one of the at least one rotatable transmission wheel in the second rotational direction causes:
the outer coil array to unlockably disengage from the housing; and
the inner coil array to lockable engage the one of the at least one rotatable transmission wheel.

20. The vehicle chassis actuator of claim 17, further comprising a screw drive rotatably driven by the transmission and the wrap spring prevents back-driving of the screw drive.
